(19) United States
(12) Patent Application Publication
(10) Pub. No.: US 2007/0290423 A1
(43) Pub. Date: Dec. 20, 2007

(54) Telescopic Pneumatic Device

(75) Inventor: Yu-Jen Wang, Tainan Hsien (TW)

Correspondence Address: HANCOCK HUGHEY LLP, P.O. BOX 6553, PORTLAND, OR, 97228, US

(73) Assignee: FU LUONG HI-TECH CO. LTD., Tainan Hsien (TW)

(21) Appl. No.: 11/670,363

(22) Filed: Feb. 1, 2007

(30) Foreign Application Priority Data
Jun. 20, 2006 (TW) 095210753

(51) Int. Cl. F16M 7/00

(52) U.S. Cl. 267/140.2

(57) ABSTRACT

A telescopic pneumatic device includes an outer cylinder, an inner cylinder disposed in the outer cylinder and having a cylinder wall defining a gas chamber, a piston mounted in the gas chamber, a piston rod connected to the piston, two flow passages formed in the cylinder wall, and a control valve operable to allow or interrupt fluid communication between a gas-controlling chamber section and a piston-receiving chamber section of the gas chamber. The inner cylinder is made of a rigid plastic material.

### BACKGROUND OF THE INVENTION

1. Field of the Invention

This invention relates to a pneumatic device, and more particularly to a telescopic pneumatic device.

2. Description of the Related Art

Referring to FIGS. 1 and 2, a conventional telescopic pneumatic device 1 disclosed in Taiwanese Patent Number 1241387 by the applicant includes an outer cylinder 11, an inner cylinder 2 disposed coaxially and fixedly within the outer cylinder 11, a piston unit 12 disposed movably within the inner cylinder 2, a conduit 13 embedded within a cylinder wall of the inner cylinder 2, a leak-preventing unit 14 disposed within a bottom end portion of the outer cylinder 11, and a control valve 15 disposed movably within a top end portion of the inner cylinder 2.

The inner cylinder 2 includes an inner cylinder wall 21 fitted within the outer cylinder 11 and defining an axially extending gas chamber 22 that has a gas-controlling chamber section 221 and a piston-receiving chamber section 222. The piston-receiving chamber section 222 is disposed under the gas-controlling chamber section 221, and has a diameter greater than that of the gas-controlling chamber section 221.

The piston unit 12 includes a piston rod 121 extending through the leak-preventing unit 14 and out of the outer cylinder 11, and a piston 122 connected fixedly to the piston rod 121. The piston 122 divides the piston-receiving chamber section 222 into a first space 223 and a second space 224 disposed under the first space 223. The conduit 13 has a radially extending horizontal passage 131 in fluid communication with the gas-controlling chamber section 221, and a vertical passage 132 extending downwardly from a radial outer end of the horizontal passage 131 and in fluid communication with the second space 224 of the piston-receiving chamber section 222.

The control valve 15 is movable between a closed position shown in FIG. 1 and an open position shown in FIG. 2. In the closed position, fluid communication between the gas-controlling chamber section 221 and the piston-receiving chamber section 222 is interrupted. In the open position, the gas-controlling chamber section 221 is in fluid communication with the piston-receiving chamber section 222 such that the first and second spaces 223, 224 are in fluid communication with each other via the conduit 13. In this state, the piston rod 121 is movable forcibly relative to the outer cylinder 11 so as to change the total length of the telescopic pneumatic device.

Since the first and second spaces 223, 224 of the piston-receiving chamber section 222 are communicated with each other by only the conduit 13, the rate of the gas flowing between the first and second spaces 223, 224 in the inner cylinder 2 is low. To increase such gas flow rate, the conduit 13 may be enlarged. However, this reduces significantly the strength of the inner cylinder wall 21.

### SUMMARY OF THE INVENTION

The object of this invention is to provide a telescopic pneumatic device that can overcome the above-mentioned drawback associated with the prior art.

According to this invention, a telescopic pneumatic device includes an outer cylinder, an inner cylinder disposed in the outer cylinder and having a cylinder wall defining a gas chamber, a piston mounted in the gas chamber, a piston rod connected to the piston, two flow passages formed in the cylinder wall, and a control valve operable to allow or interrupt fluid communication between a gas-controlling chamber section and a piston-receiving chamber section of the gas chamber. The inner cylinder is made of a rigid plastic material.

Since two flow passages are formed in the cylinder wall, the rate of the gas flowing between the gas-controlling chamber section and the piston-receiving chamber section is increased with a minimal decrease in the strength of the cylinder wall.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a schematic sectional view of a conventional telescopic pneumatic device disclosed in Taiwanese Patent Number 1241387 when a control valve is disposed in a closed position;

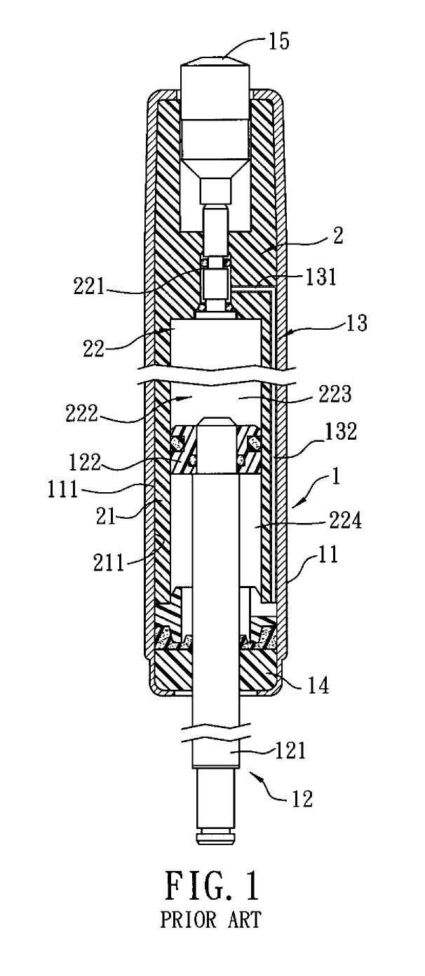

FIG. 2 is a schematic sectional view of the conventional telescopic pneumatic device when the control valve is disposed in an open position;

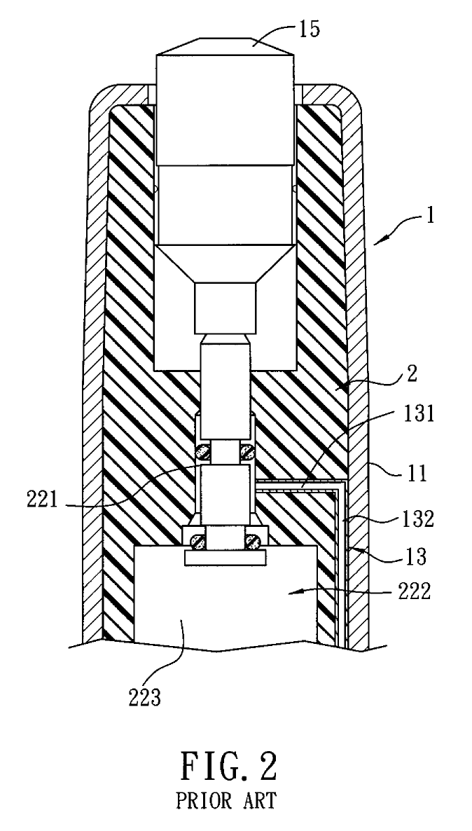

FIG. 3 is a schematic sectional view of the first preferred embodiment of a telescopic pneumatic device according to this invention when the control valve is disposed in a closed position;

FIG. 4 is a schematic sectional view of the first preferred embodiment when the control valve is disposed in an open position; and

FIG. 5 is a schematic sectional view of the second preferred embodiment of a telescopic pneumatic device according to this invention.

### DETAILED DESCRIPTION OF THE PREFERRED EMBODIMENTS

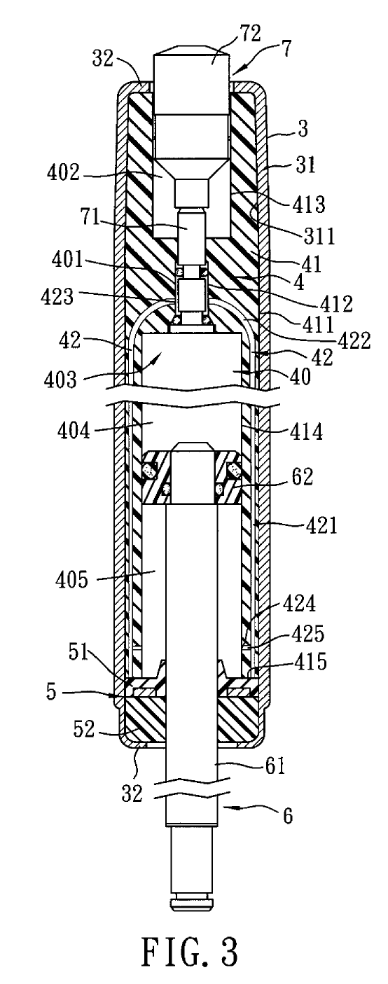

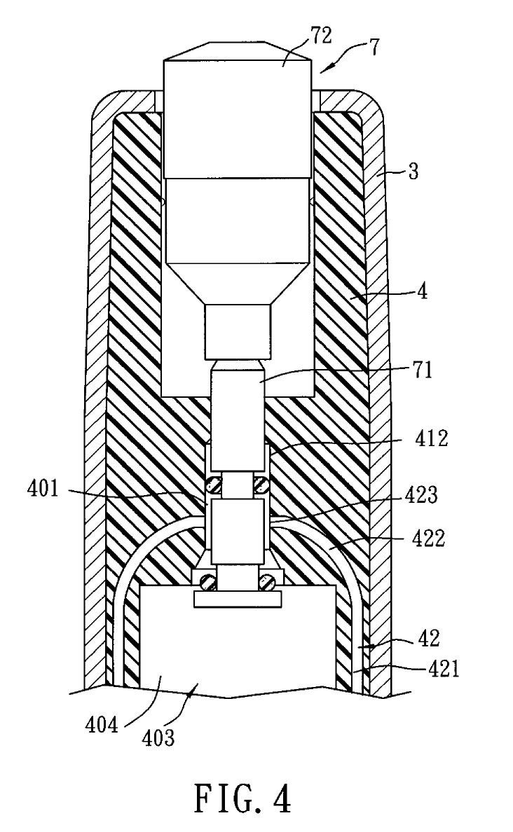

Referring to FIGS. 3 and 4, the first preferred embodiment of a telescopic pneumatic device according to this invention includes an outer cylinder 3, a unitary inner cylinder 4 disposed coaxially and fixedly within the outer cylinder 3, a leak-preventing unit 5 disposed within a bottom end portion of the outer cylinder 3, a piston unit 6 disposed within the inner cylinder 4, and a control valve 7 disposed within a top end portion of the inner cylinder 4.

The outer cylinder 3 includes an outer cylinder wall 31 having an annular inner surface 311, and top and bottom end flanges 32 extending respectively, radially, and inwardly from top and bottom ends of the outer cylinder wall 31. The top and bottom end flanges 32 are formed by pressing.

The inner cylinder 4 is made of a rigid plastic material, and has an inner cylinder wall 41 defining an axially extending gas chamber 40 therein. The gas chamber 40 has a gas-controlling chamber section 401, a valve-receiving chamber section 402 disposed above the gas-controlling chamber section 401, and a piston-receiving chamber section 403 disposed under the gas-controlling chamber section 401. The valve-receiving chamber section 402 has a diameter greater than that of the gas-controlling chamber section 401 and smaller than that of the piston-receiving chamber section 403. The inner cylinder wall 41 has an annular outer surface 411 in contact with the inner surface 311 of the outer cylinder wall 31, an annular middle inner surface 412 defining the gas-controlling chamber section 401, an annular upper inner surface 413 defining the valve-receiving chamber section 402, an annular lower inner surface 414 defining the piston-receiving chamber section 403, and a horizontal bottom surface 415 interconnecting bottom ends of the outer surface 411 and the lower inner surface 414.

The inner cylinder 4 further has two flow passages 42 extending from the middle inner surface 412 to the bottom surface 415. In this embodiment, each of the flow passages 42 has a straight passage section 421 extending in an axial direction of the inner cylinder 4 and aligned with the piston-receiving chamber section 403, a curved passage section 422 extending from a top end of the straight passage section 421, and a transverse passage section 425 extending from the straight passage section 421 into the lower inner surface 414 in a transverse direction of the inner cylinder 4. Each of the curved passage sections 422 has a first opening 423 in fluid communication with the gas-controlling chamber section 401. Each of the transverse passage sections 425 has a second opening 424 in fluid communication with the piston-receiving chamber section 403. As such, the flow passages 42 are in fluid communication with the gas-controlling chamber 401 and the piston-receiving chamber section 403. Alternatively, the number of the flow passages 42 may be increased.

The leak-preventing unit 5 includes a pair of annular upper and lower seal members 51, 52 that abut against each other and that are clamped between the bottom end flange 32 and the inner cylinder 4.

The piston unit 6 includes a piston rod 61 and a piston 62. The piston 62 is disposed movably within the piston-receiving chamber section 403, and divides the piston-receiving chamber section 403 into a pair of first and second spaces 404, 405. The first space 404 is disposed in proximity to the gas-controlling chamber section 401. The second space 405 is disposed under the first space 404, and is in fluid communication with the second openings 424. The piston rod 61 is connected fixedly to the piston 62, and extends out of the outer cylinder 3.

The control valve 7 includes a valve rod portion 71 disposed movably within the gas-controlling chamber section 401, and an actuation portion 72 extending out of the outer cylinder 3. The actuation portion 72 is operable to move the control valve 7 in the inner cylinder 4 between a closed position shown in FIG. 3 and an open position shown in FIG. 4. In the closed position, an enlarged bottom end of the gas-controlling chamber section 401 is closed by an enlarged bottom end of the valve rod portion 71 so as to interrupt fluid communication between the gas-controlling chamber section 401 and the piston-receiving chamber section 403. In the open position, the bottom end of the valve rod portion 71 is removed from the bottom end of the gas-controlling chamber section 401 such that the gas-controlling chamber section 401 is in fluid communication with the piston-receiving chamber section 403. Hence, the first and second spaces 404, 405 of the piston-receiving chamber section 403 are in fluid communication with each other via the flow passages 42 when the control valve 7 is in the open position. In this state, the piston rod 61 is movable forcibly relative to the outer cylinder 3 so as to change the total length of the telescopic pneumatic device.

Since the inner cylinder 4 has at least two flow passages 42, the rate of the gas flowing between the first and second spaces 404, 405 of the piston-receiving chamber section 403 is increased as compared to that of the above-mentioned conventional telescopic pneumatic device. The effect of such additional flow passages 42 on the strength of the inner cylinder 4 is minimal.

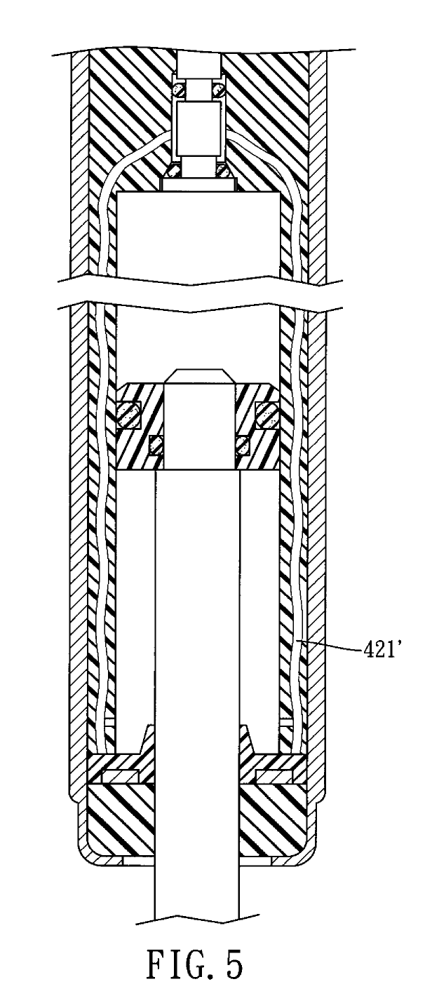

The straight passage sections 421 may be replaced with corrugated passage sections 421′ (see FIG. 5). With this invention thus explained, it is apparent that numerous modifications and variations can be made without departing from the scope and spirit of this invention. It is therefore intended that this invention be limited only as indicated by the appended claims.

I claim:

1. A telescopic pneumatic device comprising:
an outer cylinder having an outer cylinder wall;
a unitary inner cylinder made of a rigid plastic material and disposed coaxially and fixedly within said outer cylinder, said inner cylinder having an inner cylinder wall defining an axially extending gas chamber therein, said gas chamber having a gas-controlling chamber section, and a piston-receiving chamber section, said inner cylinder further having two flow passages in fluid communication with said gas-controlling chamber section and said piston-receiving chamber section, each of said flow passages having a first opening in fluid communication with said gas-controlling chamber section, and a second opening;
a piston unit including a piston disposed movably within said piston-receiving chamber section, and a piston rod connected fixedly to said piston and extending out of said outer cylinder, said piston dividing said piston-receiving chamber section into a first space disposed in proximity to said gas-controlling chamber section, and a second space in fluid communication with said second openings of said flow passages; and
a control valve movable in said inner cylinder between a closed position whereat fluid communication between said gas-controlling chamber section and said piston-receiving chamber section is interrupted, and an open position whereat said gas-controlling chamber section is in fluid communicated with said piston-receiving chamber section, such that said first and second spaces of said piston-receiving chamber section are in fluid communication with each other via said flow passages.

2. The telescopic pneumatic device as claimed in claim 1, wherein each of said flow passages has a straight passage section extending in an axial direction of said inner cylinder and aligned with said piston-receiving chamber section, a curved passage section extending from an end of said straight passage section and having a corresponding one of said first openings, and a transverse passage section extending from said straight passage section into said second space in a transverse direction of said inner cylinder.

3. The telescopic pneumatic device as claimed in claim 1, wherein each of said flow passages has a corrugated passage section aligned with said piston-receiving chamber section, a curved passage section extending from an end of said straight passage section and having a corresponding one of said first openings, and a transverse passage section extending from said corrugated passage section into said second space in a transverse direction of said inner cylinder.
